(19) United States
(12) Patent Application Publication
(10) Pub. No.: US 2004/0243566 A1
(43) Pub. Date: Dec. 2, 2004

(54) Searcher program

(76) Inventor: Mark E. Ogram, Tucson, AZ (US)

Correspondence Address: Mark E. Ogram, ste 203, 7454 E. Broadway, Tucson, AZ, 85710, US

(21) Appl. No.: 10/773,857

(22) Filed: Feb. 6, 2004

Related U.S. Application Data
(63) Continuation of application No. 09/350,404, filed on Jul. 8, 1999, now abandoned.

(51) Int. Cl. G06F 7/00

(52) U.S. Cl. 707/3

(57) ABSTRACT

On an Internet-like system, the present invention provides a system for reporting sites to a central computer. A searching computer, once a site has been found, is able to report the located site's address (commonly called the URL) together with an identifier of the searching computer to a reporting computer. The reporting computer is established to act as a central collection point for addresses which improperly contain material such as copyrighted cartoons, copyrighted articles, defamatory articles, and patented techniques. In this manner, a reporting computer is able to employ a large number of “web surfers” who are on the lookout for sites with identified materials on them.

This is a continuation of U.S. patent application Ser. No. 09/350,404, filed on Jul. 8, 1999, and entitled, “Searcher Program”.

### BACKGROUND OF THE INVENTION

This invention relates to a software and computer combination and more particularly to such a system used for Internet, World-Wide-Web, or other distributed computer system.

To say that the Internet and other like systems has had tremendous affect upon civilization would be a gross understatement. The effect of the Internet is both deep and far-reaching. It is impossible to foresee where the Internet will take civilization.

With this new-found freedom though has come an ever-widening abuse of the system. While abuses in the past were relatively minor, as the numbers of Internet users expands the volume and degree of abuse expands. For the Internet to properly grow, these abuses must be brought into check.

One area of great abuse is in the field of copyright infringement. Owners of many cartoon characters are appalled to learn that their cute character is being used to promote unauthorized products or appear in pornographic poses.

While the copyright laws (both nationally and internationally) do provide for a degree of protection from these copyright infringers, the practical problem which is faced by the copyright owner is a policing of the entire Internet. Many companies which rely upon their copyrights for the livelihood of the business employ a battalion of attorneys who “surf” the Internet for these abuses. While these “surfing” attorneys do find some infringers, the vast majority of the infringers are never found for a variety of reasons.

The inadequacy of the attorneys is a direct result of the ever expanding Internet as well as the very nature of the Net itself. All too often, sites which contain infringing content are “proprietary” requiring the viewer to pay a membership fee. The attorneys though cannot join every such service and peruse through the different files. This tactic is not cost effective and all too often the company does not want it known that they have a membership to “Polly's Porn Palace”.

It is clear that there is a need to police and find these violations of property rights.

### SUMMARY OF THE INVENTION

The present invention creates a service for copyright and trademark owners to provide a practical protection mechanism for their proprietary rights. While the present discussion is in terms of a fictitious proprietary cartoon character referenced as “Grady”, the invention is not limited only to cartoon characters, but includes all types of copyrights (i.e. photographs, newsletters, drawings) as well as trademarks and service marks. Even further, the invention applies to intelligence gathering relating to either their own company, or another company.

Once these improper uses have been identified by this invention, then traditional enforcement methods may be utilized to minimize the damage to the proprietary rights.

The invention is also useful to find cases of patent infringement. In this case, the searcher is given a framework or outline of activities where it is likely that infringement of a patent is occurring.

Still another application for the present invention is to assist a company in identifying what is being said about the company. In this application, company XYZ is able to monitor what is being said on the Internet about it and be able to address negative situations as they occur, no after the situation becomes unmanageable. A variation of this use is useful for the Securities and Exchange Commission in identifying statements that the ABC company is making about itself.

In all of these applications, the present invention's purpose of this service is to locate where certain information is being used. In the case of “Gandy”, the owner of the Gandy wants to find sites which are improperly using Gandy.

The invention is disposed on an Internet-like system. Generally, all of the computers used within the invention utilize the Internet-like system to both report and receive reports. The objective of the system is to identify where “Gandy” is being shown on a host computer. A host computer is one which contains a data file which is accessible using the Internet-like system.

A searching computer is operated by an individual. During normal “surfing” activities by the searching computer, “Gandy” is found on the host computer. Once this site containing Gandy has been found, the searching computer is able to report the site's address (commonly called the Uniform Resource Location, (“URL”) together with an identifier of the searching computer to a reporting computer.

The reporting computer is established to act as a central collection point for addresses (URLs) which improperly contain the Gandy material. This collection of addresses is communicated to the owner of Gandy so that proper action can be taken.

The reporting computer also pays a “reward” to the operator of the searching computer. While the preferred “reward” is in the form of cash, other incentives are also useful such as, but not limited to: discounts on computer equipment; free access to the Internet; and, free trips.

In the preferred embodiment, as much as is possible is performed automatically. The reporting computer's operation (from creation of the data to support the search for Gandy infringements, to payment of rewards to the searcher) is ideally fully automatic.

Operation of the system of this invention utilizes four computers:

1) Hosting Computer which contains the improperly used Gandy material;

2) Reporting Computer which contains information on Gandy;

3) Client Computer, the owner of the Gandy material; and,

4) Searching Computer which seeks out the Hosting Computer to report it to the Reporting Computer.

Within the preferred embodiment, the Reporting Computer, the Client Computer and the Searching Computer operate as outlined below:

Client Computer: This computer is directed by a human operator (owner of Gandy) to interact with the Reporting Computer. Information, whether created by the operator or generated automatically, is communicated to the Reporting Computer. The preferred steps are:

The prospective client enters his/her contact information, (i.e. who they are—name, address, title within company, e-mail);

The Client identifies the mark/copyright to be sought (i.e. Gandy) and uploads any images or other reference material that is needed;

In the embodiment were cash rewards are to be used to provide incentives, the Client establishes if there is a limit on the amount they want to spend in the search;

The Client enters the time frame for the search (i.e. a month, a week);

To avoid duplication of sites where Gandy is authorized, the Client enters the URLs which have legitimate right to use Gandy.

All of this information is ideally communicated via the Internet to the Reporting Computer.

Searching Computer: The operator of this computer utilizes his/her computer together with access to the Internet to seek out the improper uses of Gandy. Usually prior to performing the search, the individual, via the Internet:

Signs in with the Reporting Computer and is given an identifier and password;

Reviews what marks/copyrights are being sought (i.e. Gandy);

If he/she wants, reviews a list of legitimate URLs where Gandy appears so that a legitimate URL is not improperly reported; and,

If he/she wants, reviews a list of already found sites which have Gandy.

Once Gandy is found on the Host Computer, the Searching Computer is able to activate a reporting program which links the Searching Computer with the Reporting Computer via the Internet. The preferred reporting program allows:

The searching program to provide the Host URL and the Searching Computer's identification to the Reporting Computer;

The Reporting Computer accepts or rejects the Host URL depending on if the Searching Computer is the first to report the Host site;

The Searcher, via the searching computer, is able to review on-line reports on his/her earned rewards for finding an improperly used Gandy; and,

The Searching Computer is able to activate payment from the Reporting

Computer by either check or as a credit on a previously defined credit card. Reporting Computer: Preferably, this computer works substantially automatically with very little input from human operators. In this context, the Reporting computer provides that:

URL sites identified by the Searching Computer are automatically pulled, dated, and communicated to the Client Computer using the Internet;

A central domain registration service (i.e. Internic) is polled on the identified URL, this information is also sent to the Client Computer using the Internet;

If payment requested to by the Searching Computer via credit card, credit is made and adjustment to accounting is made;

If the Searching Computer requests payment by check, a check is prepared and mailed;

The invention, together with various embodiments thereof, will be more fully explained by the accompanying drawings and the following description thereof.

### DRAWINGS IN BRIEF

FIG. 1 illustrates an Internet environment in which the present invention is applied.

FIG. 2 illustrates the preferred arrangement for the searcher's screen.

FIG. 3 is a flow-chart of the preferred reporter program.

FIG. 4 is a flow-chart of the preferred searcher program.

FIG. 5 is a flow-chart of the preferred client program.

### DRAWINGS IN DETAIL

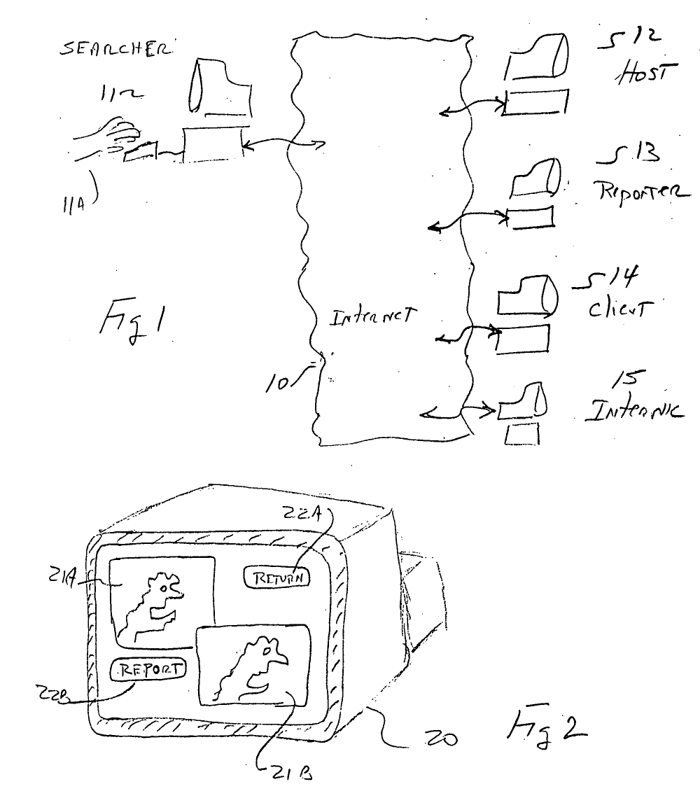

FIG. 1 illustrates an Internet environment in which the present invention is applied.

The Internet 10 creates a system for remote computers to share data. In this illustration, the host computer has certain data that it is making available on the Internet 10. This data often takes the form of images, text, or some combination thereof. To locate the host data from host computer 12, a remote computer “points” to the host data by its Uniform Resource Location (URL) and the host data is automatically downloaded to the remote computer via Internet 10.

The host data is placed “on” the Internet 10 and is picked up by searcher computer 11 operated by user 11A. Finding the host data is done usually through the use of a “browser” program which assists user 11A in finding a specific topic.

In a prior operation, user 11A, via searcher computer 11 and Internet 10, established a “relationship” with reporter computer 13. This “relationship” involved the creation of a searcher identification being established with reporter computer 13. The relationship also allows searcher computer 11 to gain access to specific materials which identify what is being sought by reporting computer 13.

As noted earlier, these items being sought range from copyrighted cartoon characters (such as Gandy in the above example) to discussions conducted on specific companies (where a company wants to monitor what is being said about it).

These specific items contained within reporter computer 13 were previously established by a client computer 14.

Returning to the linkage between searcher computer 11 and host computer 12, the host data, with its unique URL, is communicated to the searcher computer 11 via the Internet 10. Once the host data is received, searcher computer 11 displays the information which is analyzed by user 11A. If user 11A suspects that the host data falls within the realm of what the reporting computer 13 is seeking, user 11A activates a program (sometimes contained on searcher computer 11, in other situations the program is resident on reporter computer 13). This program permits user 11A to convey his/her identification (as previously established) together with information on the host data to reporter computer 13.

Reporter computer 13 utilizes a data base of previously reported URLs together with client established URLs (sites which have permission to use the material), to determine if the latest URL is new. If the latest URL is new, it is added to the data base and a credit, based upon user 11A identification is made within an accounting files. This credit is meant to “reward” user 11A for reporting the host data to the reporter computer 13.

The searcher computer 11 is then able to return to tasks demanded by user 11A.

Periodically, reporter computer 13 provides client computer 14 with a report on all of the sites (URLs) which have been found. This report, in some embodiments, is supplemented with information from Internic computer 15 which provides information on the host computer 12 based upon the host URL.

In the preferred embodiment, the reporter computer 13 operates automatically allowing the client computer 14 to interact with it and also allowing the searcher computer 11 to automatically interact with the reporter computer 13.

In this manner, the client computer 14 establishes what it wants to have sought; the reporter computer 13 presents the material to the “public” (the searcher computer(s) 11); and the searcher computer(s) 11 report on what they find available through the Internet 10.

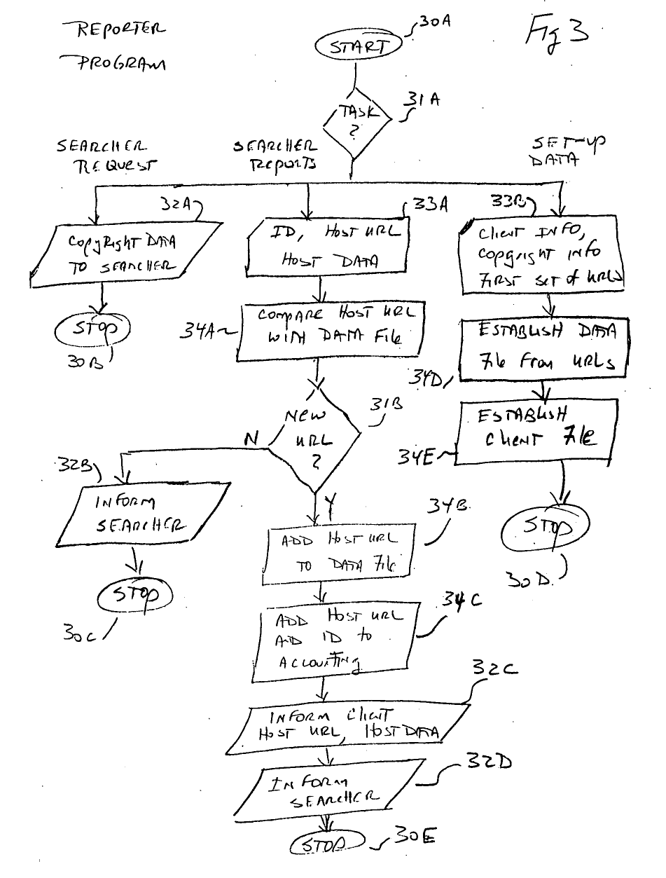

FIG. 2 illustrates the preferred arrangement for the searcher's screen.

Screen 20, as shown, is configured to present both the host data 21A as well as the material being sought 21B. The host data 21A had been collected from the remote host computer; the material sought 21B had been collected from the remote reporting computer.

The user is able to compare the two images (showing the fictitious “Gandy”) and determine if the host data 21A could arguably be considered a copyright infringement of the sought material 21B.

If the user determines that the host data 21A should be reported, the “report” button 22B is engaged by the user and the information is communicated to the remote reporting computer.

If the user determines that the host data 21A should not be reported, the “return” button 22A is activated and the program linking the searching computer with the reporting computer is terminated and only the host data is shown (sometimes “refreshed”).

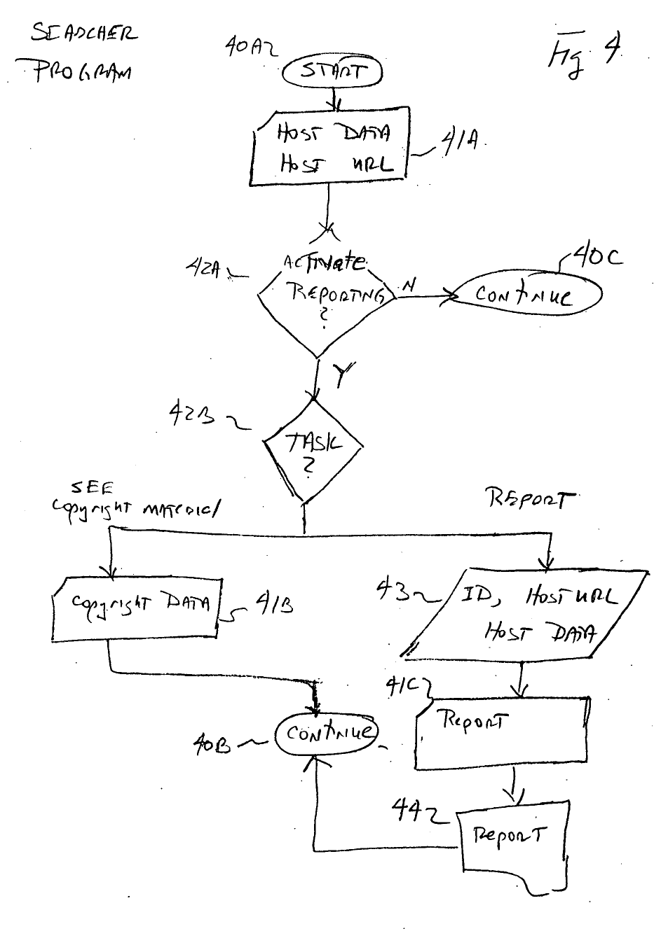

FIG. 3 is a flow-chart of the preferred reporter program. The reporter program, in this embodiment of the invention, serves as a central clearing point for the client computers and the searcher computers.

Once the program starts 30A, the task 31A is determined. In this embodiment, the tasks are: Searcher Requests Information; Searcher Reports a URL; and, the Client sets up the search parameters. An additional task of assigning the Searcher Computer an identification is not shown due to its simplicity (i.e. the Searcher Computer requests an identification, an identification is assigned).

If the task 31A chosen is to set-up the data file for the search, information regarding the client, the copyright sought, and a first set of URLs is received 33B. Using the first set of URLs (typically the sites which have authorization to use the material), the data file is created 34D. A reference file containing the client information is created (usually for accounting purposes and for correspondence) 34E; the program then stops 30D.

If the task chosen 31A is a request from the searcher on which materials are being sought, then the copyright data which the client established is communicated to the searcher 32A and the program stops 30B.

If the task chosen 31A is for the searcher to report a site, then the program receives the searcher identification, the host's URL (the site being reported), as well as the host data (sometimes in the form of an image) 33A.

The reported Host URL is compared with the data file 34A and a determination is made on if the reported Host URL is a new site or if the site has been reported earlier 31B.

If the reported Host URL is not new (i.e. it was reported earlier or is authorized by the client), then the searcher is informed 32B and the program stops 30C.

If the reported Host URL is new, 31B, then the reported Host URL is added to the data file 34B (to prevent others from reporting the same site) and the Host URL and Searcher Identification is placed in an account file 34C (so that the Searcher can be paid their reward).

The Host URL and Host data is then reported to the client 32C and the Searcher is informed that the report has been accepted 32D. The program then stops 30E.

In some embodiments of the invention, Internic or some other registry is contacted and information concerning the Host (based upon the reported URL) is collected and sent to the client as well.

If the task chosen 31A is to provide data to the Searcher, then the copyright data is sent to the Searcher 32A and the program stops 30B. This segment of the program is useful in providing information concerning what content is being sought and also for use in comparing the sought materials with what has been found by the Searcher.

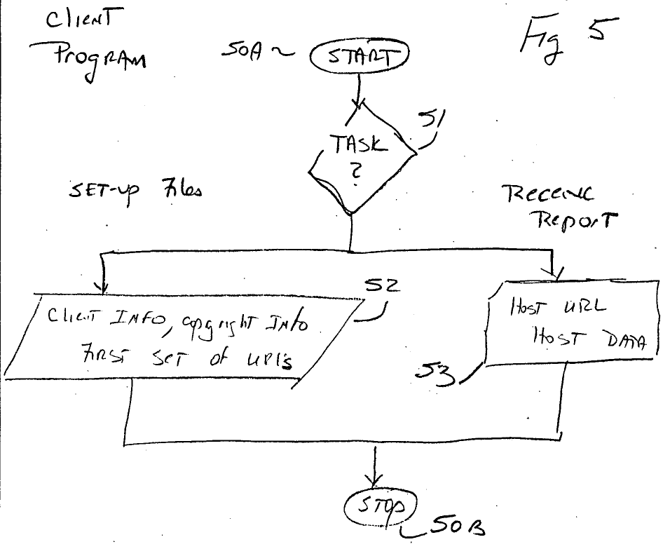

FIG. 4 is a flow-chart of the preferred searcher program.

The searcher program interacts with the reporter program described in FIG. 3. Once start has occurred 40A, the host data and host URL is obtained 41A via the Internet. The user then determines if he/she wants to activate the reporting program 42A. If the user does not want to make any reports, the program continues 40C (usually as a traditional browser or as “refreshed” images from the host computer).

Should the user want to make a report 42A, then the task must be chosen by the user 42B. The available tasks are to review the copyrighted material or to report a site.

If the user wants to see copyrighted material, then the copyrighted material is requested and received 41B from the Reporter Program (activity 32A of FIG. 3). The program then continues 40B.

If the user wants to report a site, then the user's ID, the Host URL, and preferably the Host data is communicated to the Reporter Program 43 (input 33A of FIG. 3). The Searcher Program receives a report back from the Searcher Program 41C (activity 32D of FIG. 3) which is displayed or printed 44. The program continues 40B.

As is obvious, the activity at the Searcher Program is minimal with the Reporter Program (FIG. 3) performing the clerical and recording tasks.

FIG. 5 is a flow-chart of the preferred client program.

Once the client starts his program 50A, the selected task is identified 51. These tasks include the setting up of files and the receiving of reports.

If the client wants to set-up the files with the Reporter computer, data consisting of the client information (name, address, etc.), the copyrighted material which is sought, and a list of previously identified URLs is communicated 52 (received the Reporter program as activity 33B). The program then stops 50B.

If the client wants to receive reports, then information on the Host URL and the Host Data is received 53 (as sent by activity 32C of FIG. 3). The program then stops 50B.

It is clear that the present invention provides a highly improved apparatus and method of policing a distributed network of computers.

What is claimed is:

1. An Internet system comprising:
a) a communication network for remote computers;
b) a host computer providing host data via said communication network to remote computers, said host data identified by a unique host address;
c) a searching computer having a unique user indicia contained therein, said searching computer, in response to directions from a user of said searching computer, containing data originating from a host computer with an associated host address; and,
d) a reporting computer connected to said communication network, said reporting computer having
1) a data base of addresses,
2) memory means for storing a user identification therein, and,
3) means for:
A) receiving an inquiry having a user identification and inquiry address, and,
B) if said inquiry address does not correspond to any address within said data base,
1) storing said inquiry address in said data base, and,
2) providing a reward to a user associated with said reporter identification; and,
wherein said searching computer has means for communicating said user indicia and said host address as an inquiry address to said reporting computer.

2. The Internet system according to claim 1, wherein said reward provided to the user of said searching computer is in the form of cash.

3. The Internet system according to claim 2, wherein said reward is provided as a credit on a credit card.

4. The Internet system according to claim 2, wherein said reward is communicated via check to the user of said searching computer.

5. The Internet system according to claim 1,
a) wherein said reporting computer further includes:
1) image data stored within said memory means; and,
2) means for communicating said image data to a requesting computer; and,
b) wherein said searching computer includes means for requesting said image data from said reporting computer.

6. The Internet system according to claim 5, wherein said searching computer includes means for displaying said image data from said reporting computer.

7. The Internet system according to claim 1,
a) further including a client computer connected to said communication network; and,
b) wherein said reporting computer includes,
1) means for communicating a suspect image from said host computer at said inquiry address; and,
2) means for communicating said suspect image and said inquiry address to said client computer via said communication network.

8. A computer connected to remote computers via an Internet-like system comprising:
a) a data base of addresses, and,
b) means for:
1) receiving an inquiry address,
2) if said inquiry address does not correspond to any address within said data base,
A) storing said inquiry address in said data base, and,
B) providing a reward to a user associated with a user associated with submission of said inquiry address.

9. The computer according to claim 8, wherein said reward provided to the user is in the form of cash.

10. The computer according to claim 9, wherein said reward is provided as a credit on a credit card.

11. The computer according to claim 9, wherein said reward is communicated via check to the user of said searching computer.

12. The computer according to claim 9, further including:
a) image data; and,
b means for communicating said image data to a requesting computer.

13. An Internet system utilizing a communication network, said system comprising:
a) a host computer identified by a unique host address and providing host data via said communication network to remote computers;
b) a searching computer having a unique user indicia contained therein, said searching computer containing data originating from a host computer with an associated host address; and,
c) a reporting computer having:
1) a data base of addresses,
2) means for:
A) receiving an inquiry having a user identification and inquiry address via said communication network, and,
B) if said inquiry address does not correspond to any address within said data base,
1) storing said inquiry address in said data base, and,
2) providing a reward to a user associated with said reporter identification; and,
wherein said searching computer has means for communicating said user indicia and said host address as an inquiry address to said reporting computer.

14. The Internet system according to claim 13, wherein said reward provided to the user of said searching computer is in the form of cash.

15. The Internet system according to claim 14, wherein said reward is provided as a credit on a credit card.

16. The Internet system according to claim 14, wherein said reward is communicated via check to the user of said searching computer.

17. The Internet system according to claim 13,
a) wherein said reporting computer further includes:
1) image data stored within said memory means; and,
2) means for communicating said image data to a requesting computer; and,
b) wherein said searching computer includes means for requesting said image data from said reporting computer.

18. The Internet system according to claim 17, wherein said searching computer includes means for displaying said image data from said reporting computer.

19. The Internet system according to claim 13,
a) further including a client computer connected to said communication network; and,
b) wherein said reporting computer includes,
1) means for communicating a suspect image from said host computer at said inquiry address; and,
2) means for communicating said suspect image and said inquiry address to said client computer via said communication network.
